(19) United States
(12) Patent Application Publication
(10) Pub. No.: US 2015/0316800 A1
(43) Pub. Date: Nov. 5, 2015

(54) DISPLAY PANEL STRUCTURE

(71) Applicant: HANNSTAR DISPLAY CORPORATION, Taipei City (TW)

(72) Inventors: Chun-Chiang CHEN, Taipei City (TW); Chuan-Tzong KUO, Taipei City (TW)

(21) Appl. No.: 14/699,626

(22) Filed: Apr. 29, 2015

(30) Foreign Application Priority Data
Apr. 30, 2014 (CN) 201410183095.5

(51) Int. Cl. G02F 1/1339

(52) U.S. Cl. CPC G02F 1/1339

(57) ABSTRACT

A display panel structure comprises a first substrate, a second substrate, at least an array, a plurality of liquid crystal display (LCD) units, a plurality of first sealants and at least a second sealant. The second substrate is disposed corresponding to the first substrate. The array is disposed between the first substrate and the second substrate. The LCD units are disposed within the array. The first sealants are disposed on the outside of the LCD units, respectively. The second sealant is disposed on the outside of the array in a multi-segment manner. Thereby, the problems of the substrate peeling and fragment occurring in the process of the dorsal plating to form a conducting layer can be improved, and the internal strike effect of the liquid crystal can be restrained, so as to enhance the technical yield.

### CROSS REFERENCE TO RELATED APPLICATIONS

This Non-provisional application claims priority under 35 U.S.C. §119(a) on Patent Application No(s). 201410183095.5 filed in People's Republic of China on Apr. 30, 2014, the entire contents of which are hereby incorporated by reference.

### BACKGROUND OF THE INVENTION

1. Field of Invention

This invention relates to a display panel structure.

2. Related Art

Liquid crystal display (LCD) apparatuses, having advantages such as low power consumption, less heat, light weight and non-radiation, are widely applied to various electronic products and gradually take the place of cathode ray tube (CRT) display apparatuses.

In general, the liquid crystal display apparatus mainly comprises an LCD panel, a driving module and a backlight module. The LCD panel mainly includes a thin film transistor (TFT) substrate, a color filter (CF) substrate and a liquid crystal layer between the two substrates.

In the conventional manufacturing process of an LCD panel, a plurality of sealants will be disposed on the TFT substrate, and the region within each of the sealants will be filled with liquid crystal molecules, and then a display panel structure including a plurality of LCD units can be obtained after the TFT substrate and the CF substrate are attached to each other under vacuum and the sealants are cured. Then, an additional sealant will be disposed on the edges of the panel structure, and then a plurality LCD panels can be obtained after the processes of the substrate thinning, dorsal plating to form a transparent conducting layer and slicing.

However, during the process of the dorsal plating to form a transparent conducting layer, a transparent conducting layer needs to be formed on the outer surface of the CF substrate under vacuum, and therefore the problems of the substrate peeling and fragment will be caused. Moreover, since the sealant is not completely cured when the TFT substrate and the CF substrate are attached to each other under vacuum, the internal strike effect where the liquid crystal molecules strike the sealant (the condition will become more serious with the less panel size) will occur after the attached substrates return to the atmosphere environment. This will result in the LC leakage and the yield will be thus reduced.

### SUMMARY OF THE INVENTION

An objective of this invention is to provide a display panel structure whereby the problems of the substrate peeling and fragment occurring in the process of the dorsal plating to form a transparent conducting layer can be improved, and besides, the internal strike effect can be restrained so as to enhance the technical yield.

To achieve the above objective, a display panel structure according to the invention comprises a first substrate, a second substrate, at least an array, a plurality of liquid crystal display (LCD) units, a plurality of first sealants and at least a second sealant. The second substrate is disposed corresponding to the first substrate. The array is disposed between the first substrate and the second substrate. The LCD units are disposed within the array. The first sealants are disposed on the outside of the LCD units, respectively. The second sealant is disposed on the outside of the array in a multi-segment manner.

In one embodiment, the second sealant disposed between the edges of the array and the first substrate is a double-layer and multi-segment structure.

In one embodiment, the second sealant disposed between the edges of the array and the first substrate at each of four corners includes a double-layer structure.

In one embodiment, the distance between two adjacent segments of the second sealant is greater than 3 cm.

In one embodiment, the length of each segment of the second sealant is less than or equal to 30 cm.

In one embodiment, the display panel structure further comprises at least a transparent conducting layer disposed on an outer surface of the first substrate or second substrate.

In one embodiment, the transparent conducting layer is a polycrystalline patterned transparent conducting layer.

In one embodiment, the display panel structure comprises a plurality of arrays and a plurality of second sealants disposed between the arrays.

In one embodiment, the second sealants are disposed between the edges of the arrays and first substrate.

In one embodiment, the second sealants are arranged into an array formed by columns and rows, and the two adjacent second sealants along the column direction or row direction form an interval region.

In one embodiment, the LCD units are fringe field switching (FFS) LCD units or in-plane switch (IPS) LCD units.

In one embodiment, the display panel structure further comprises a third sealant sealing the edges of the first substrate and second substrate.

As mentioned above, in the display panel structure of this invention, the array is disposed between the first substrate and the second substrate and the LCD units are disposed within the array. Besides, the first sealants are disposed around the LCD units, respectively, and the second sealant is disposed on the outside of the array in a multi-segment manner. Thereby, in comparison with the conventional art, the problems of the substrate peeling and fragment occurring during the process of forming the transparent conducting layer for the display panel structure under vacuum can be improved, and the internal strike effect occurring when the first substrate and the second substrate are attached to each other under vacuum and then return to the atmosphere environment can be restrained, so as to enhance the technical yield.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic top-view diagram of a display panel structure of an embodiment of the invention;

FIG. 1B is a schematic exploded diagram of the display panel structure in FIG. 1A;

FIG. 1C is another schematic top-view diagram of a display panel structure of an embodiment of the invention;

FIG. 1D is a schematic exploded diagram of the display panel structure in FIG. 1B;

FIG. 2A is a schematic top-view diagram of the display panel structure of another embodiment of the invention;

FIG. 2B is a schematic exploded diagram of the display panel structure in FIG. 2A; and

FIGS. 3A to 3G are schematic top-view diagrams of the display panel structures of different embodiments of the invention.

### DETAILED DESCRIPTION OF THE INVENTION

The present invention will be apparent from the following detailed description, which proceeds with reference to the accompanying drawings, wherein the same references relate to the same elements.

In order to clearly show the features of this invention, each of the first sealant and the second sealant is shown by a dotted line in the following top-view diagrams, but in fact, each of them is a layer structure with a certain width.

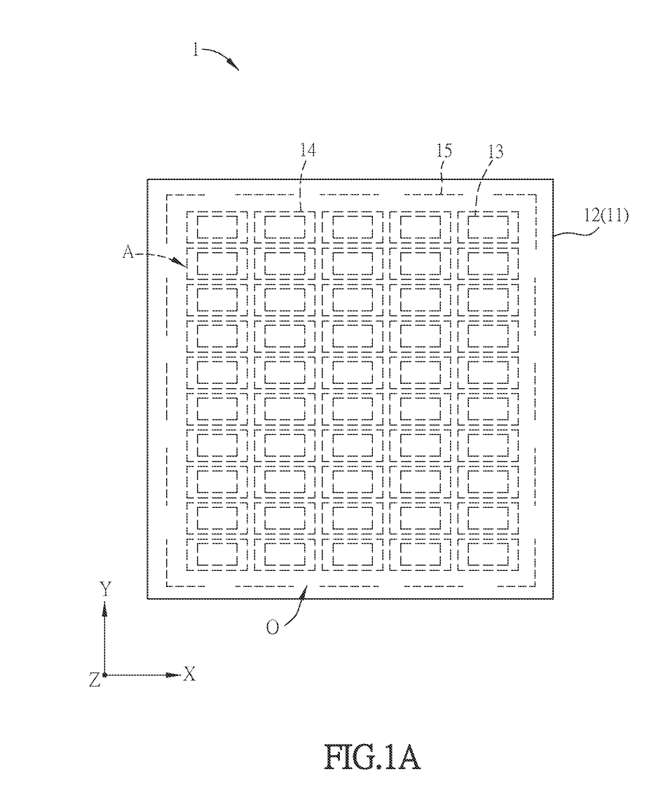

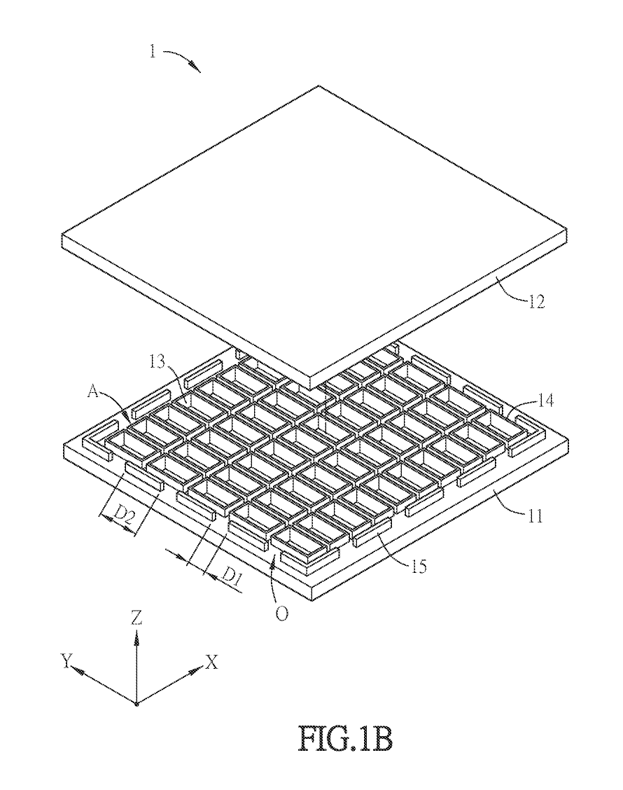

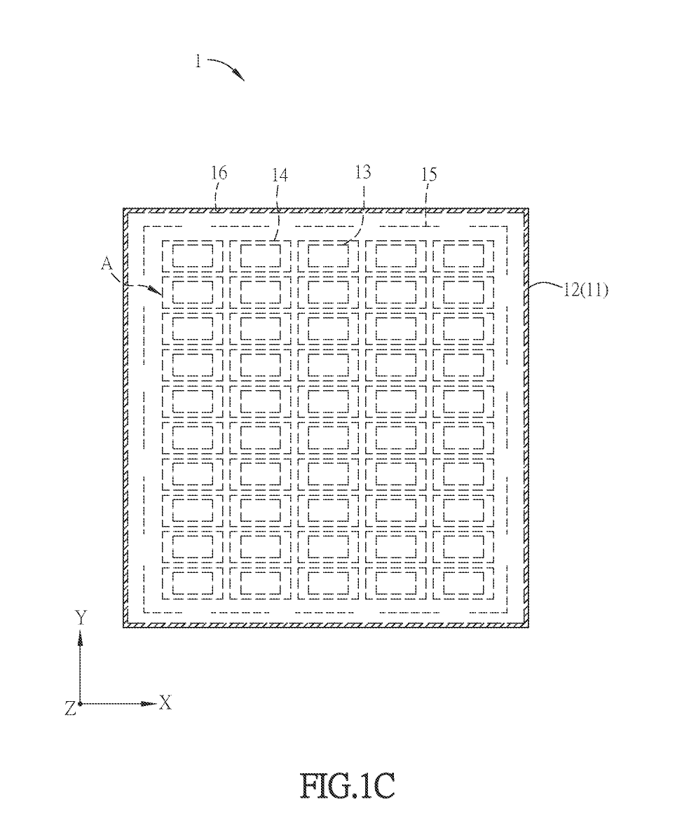

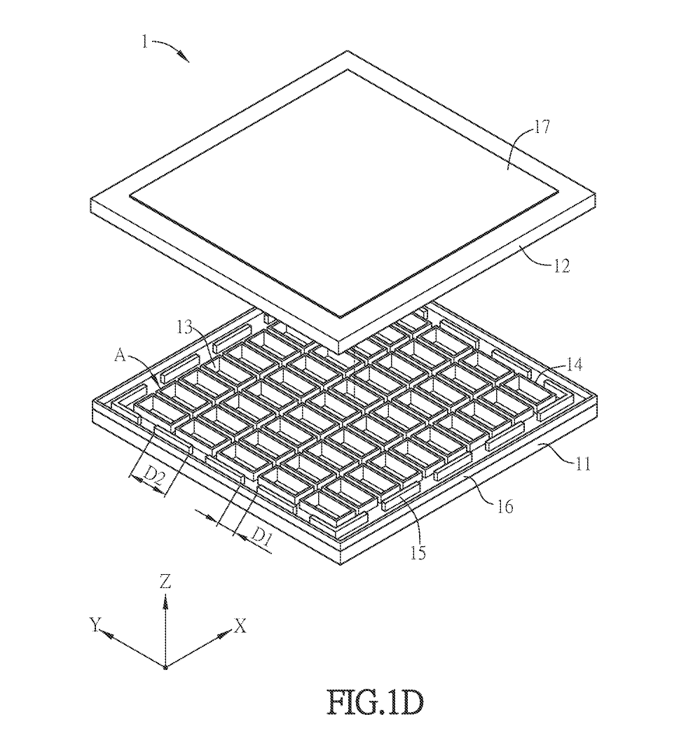

FIG. 1A is a schematic top-view diagram of a display panel structure 1 of an embodiment of the invention, and FIG. 1B is a schematic exploded diagram of the display panel structure 1 in FIG. 1A.

The display panel structure 1 includes a first substrate 11, a second substrate 12, at least an array A, a plurality of liquid crystal display (LCD) units 13, a plurality of first sealants 14 and at least a second sealant 15. Herein, a single array A and a single second sealant 15 are given as an example. The second sealant 15 is a multi-segment structure disposed on the outside of the array A.

The first substrate 11 and the second substrate 12 are disposed correspondingly. The first substrate 11 or the second substrate 12 can be made by transparent material, such as glass, quartz or the like, plastic material, fiberglass or other polymer materials. The first substrate 11 or the second substrate 12 can also be made by opaque material, such as a metal-fiberglass composite plate, a metal-ceramic composite plate, a printed circuit board or other types. In this embodiment, the material of the first substrate 11 and second substrate 12 is transparent glass for example. The first substrate 11 can include at least a TFT array and the second substrate 12 can include at least a CF array and a black matrix. However, in other embodiments, the color filter layer of the CF array or the black matrix may be disposed on the first substrate 11 for making a COA (color filter on array) substrate or a BOA (BM on array) substrate. To be noted, the above-mentioned structures are just for example but not for limiting the scope of the invention.

The array A is disposed between the first substrate 11 and the second substrate 12, and the LCD units 13 are disposed in the array A. In this embodiment, the LCD units 13 are disposed into a matrix formed by columns (the direction Y) and rows (the direction X) to become the array A (two-dimensional array). Each of the LCD units 13 can be a fringe field switching (FFS) LCD unit or an in-plane switch (IPS) LCD unit (for FFS and IPS, a covering electrode disposed on the substrate is required for preventing the static electricity from affecting the display quality), but this invention is not limited thereto.

The first sealants 14 are disposed around the LCD units 13, respectively. The first sealant 14 can be a thermo-curing adhesive, a photo curing-adhesive or their combination. Herein for example, the first sealant 14 is a photo-curing adhesive (such as UV adhesive), and is, for example but not limited to, formed on the first substrate 11 in a coating manner under atmosphere environment. As shown in FIG. 1B, each of the first sealants 14 is disposed in an annular manner to form a containing space, and therefore the liquid crystal molecules can be filled into the containing space of the first sealant 14 to form an LCD unit 13. The liquid crystal molecules are, for example but not limited to, filled in the regions of the first sealants 14 by the one drop filling (ODF) process, so that the first sealants 14 are disposed around the LCD units 13, respectively.

The second sealant 15 is disposed on the outside of the array A in a multi-segment manner. In physical, the second sealant 15 of this embodiment includes a plurality of segments (an opening 0 exists between one segment and another segment), and these segments are disposed on the outside of the LCD units 13 which are formed in an array. As shown in FIG. 1B, the distance Dl between the two segments of the second sealant 15 can be greater than 3 cm (i.e. the opening O between the two segments is at least 3 cm). Besides, the length D2 of each segment of the second sealant 15 can be less than or equal to 30 cm (i.e. D2 30 cm). However, in other embodiments, the length D2 of each segment of the second sealant 15 can be greater than 30 cm. The second sealant 15 can be a thermo-curing adhesive, a photo-curing adhesive or their combination. Herein for example, the second sealant 15 is the combination of a thermo-curing adhesive and a photo-curing adhesive. For example, the second sealant 15 can be formed on the first substrate 11 in a multi-segment coating manner under atmosphere environment and disposed on the outside of the LCD units 13 which are disposed in the array A. Then, the first sealants 14 and the second sealant 15 can be cured. For example, the second sealant 15 can be illuminated by UV light under atmosphere environment (not completely curing), and then a baking process for completely curing the first sealant 14 and the second sealant 15 will be conducted by an oven.

As shown in FIGS. 1C and 1D, the main difference from FIGS. 1A and 1B is that the display panel structure in FIGS. 1C and 1D can further include a third sealant 16 which is disposed on the edges of the first substrate 11 and second substrate 12 and seals the first substrate 11 and second substrate 12. Herein for example, the third sealant 16 is a photo-curing adhesive (such as UV adhesive) and can be formed on the edges of the first substrate 11 and second substrate 12 in a coating manner. However, this invention is not limited thereto. Thereby, the chemical agent used in the subsequent process can be prevented from damaging the inner structure of the display panel structure 1. After being disposed, the third sealant 16 can be cured. To be noted, the substrate thinning can be further implemented, wherein the grinding, polishing or etching treatment can be used to reduce the thickness of the first substrate 11 and second substrate 12 as less than 0.4 mm, for example.

The display panel structure 1 can further include at least a transparent conducting layer 17, which is disposed on the outer surface of the first substrate 11 or second substrate 12. Herein for example, the transparent conducting layer 17 can be formed on the outer surface of the second substrate 12 under vacuum. The material of the transparent conducting layer 17 is, for example but not limited to, indium-tin oxide (ITO), indium-zinc oxide (IZO) or other kinds of material. If the LCD units 13 of the display panel structure 1 are FFS or IPS LCD units, the transparent conducting layer 17 can act as the electrostatic protection layer of the LCD units 13 so as to enhance the electrostatic protection function of the display panel structure 1. If the LCD units 13 are touch LCD units 13 (FFS or IPS), the display panel structure 1 can be applied to the on-cell touch panel for example and the transparent conducting layer 17 can be the touch sensing layer (can include the driving electrode and sensing electrode, not shown). The transparent conducting layer 17 can be the patterned polycrystalline transparent conducting layer (the pattern is not shown in the figure), which can be formed from the transformation of the amorphous transparent conducting layer. To be noted, the method of forming the patterned polycrystalline transparent conducting layer can include the following steps of: forming at least an amorphous transparent conducting layer (material such as ITO) on the surface of the second substrate 12; patterning the amorphous transparent conducting layer by high energy pulse to make the patterned amorphous transparent conducting layer transformed into the patterned polycrystalline transparent conducting layer; and removing the non-patterned amorphous transparent conducting layer by etching. In practice, for example, the amorphous transparent conducting layer may be formed on the outer surface of the second substrate 12 by sputtering and the thickness thereof is between 200 Å and 800 Å. Then, the excimer laser annealing (ELA) is implemented to the amorphous transparent conducting layer, wherein the high energy pulse directly patterns the amorphous transparent conducting layer and the amorphous transparent conducting layer is thus exposed to the high temperature in a very short time to be transformed into the patterned polycrystalline transparent conducting layer. Subsequently, the etching technique is used, so that the chemical agent (such as oxalic acid) which just can etch the amorphous material is used to remove the non-patterned amorphous transparent conducting layer to obtain the patterned polycrystalline transparent conducting layer. The polycrystalline transparent conducting layer has better electrical conductivity than the amorphous transparent conducting layer. Moreover, the patterning achieved by the laser can save a step of photoresist technique, such as exposure and development. After forming the transparent conducting layer 17, a slicing technique will be further implemented (not shown) to obtain the LCD panel or touch display panel including a plurality of LCD units 13.

Through the demonstration, when the second sealant 15 of the display panel structure 1 of this embodiment is disposed on the outside of the array A in a multi-segment manner, in comparison with the conventional art, the problems of the substrate peeling and fragment occurring during the process of forming the transparent conducting layer on the outer surface of the second substrate 12 can be improved, and besides, the internal strike effect where the liquid crystal molecules strike the sealant occurring when the first substrate 11 and the second substrate 12 are attached to each other under vacuum and the first sealant 14 is not cured can be restrained, so as to enhance the technical yield.

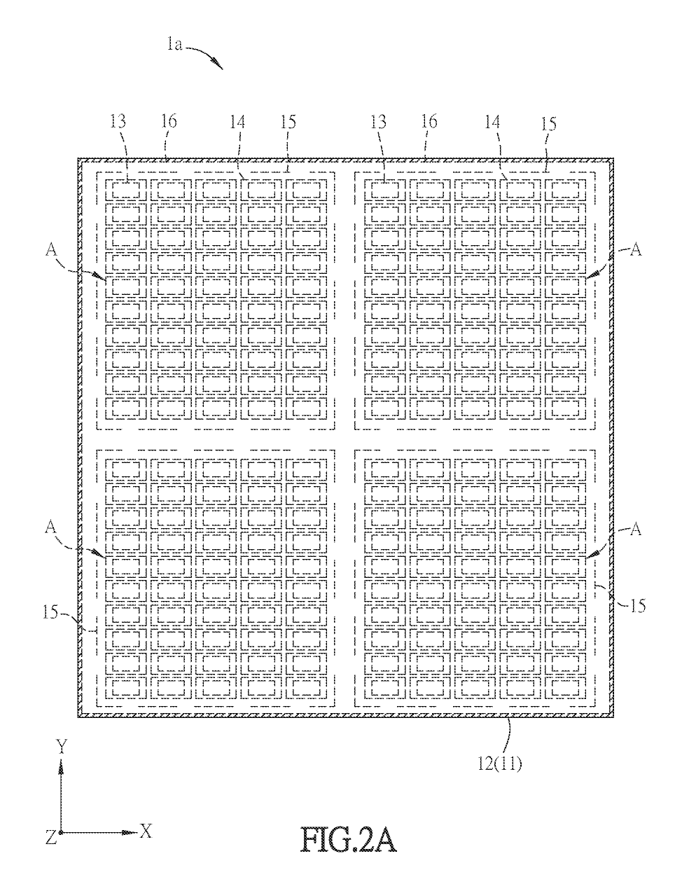

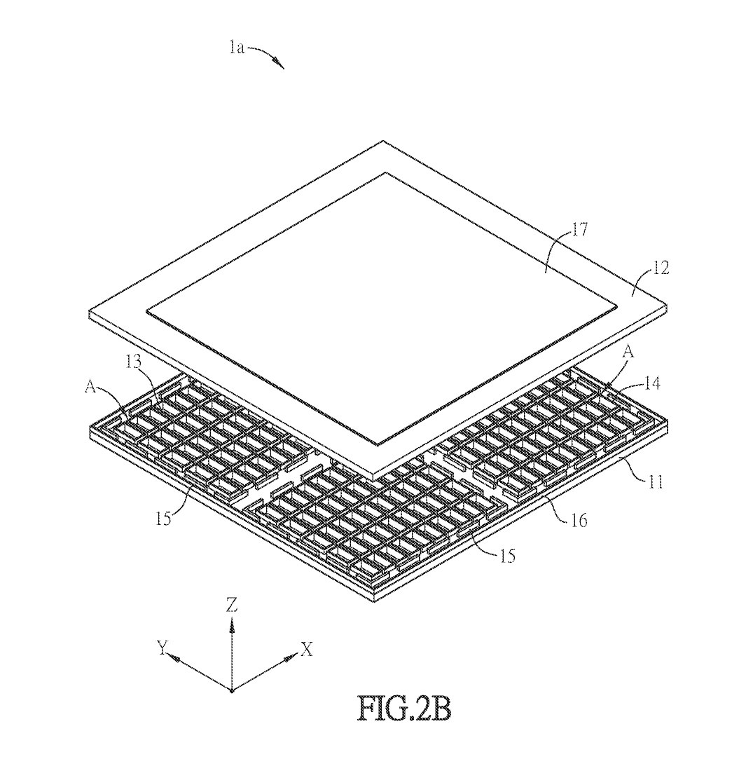

FIG. 2A is a schematic top-view diagram of the display panel structure 1a of another embodiment of the invention, and FIG. 2B is a schematic exploded diagram of the display panel structure 1a in FIG. 2A.

As shown in FIGS. 2A and 2B, the main difference from the display panel structure 1 is that the display panel structure 1a includes four arrays A and four second sealants 15. The arrays A are arranged into a two-dimensional matrix, and each of the second sealants 15 is disposed on the outside of the LCD units 13 of the corresponding array A, so that the display panel structure 1a is a four-section board. The second sealants 15 are disposed between the arrays A and between the edges of the arrays A and the first substrate 11. Moreover, the second sealants 15 are disposed separately, so that an interval region exists between two adjacent second sealants 15. In other words, the second sealants 15 are arranged into a matrix formed by columns (the direction Y) and rows (the direction X), and the two adjacent second sealants 15 along the column or row direction form the interval region therebetween. Herein, as shown in FIG. 2A, the two adjacent second sealants 15 along the direction Y are disposed separately and the two adjacent second sealants 15 along the direction X are also disposed separately, so that the cross-like interval region is formed on the four-section board.

Other technical features of the display panel structure 1a can be comprehended by referring to the display panel structure 1, so the related illustration is omitted here for conciseness.

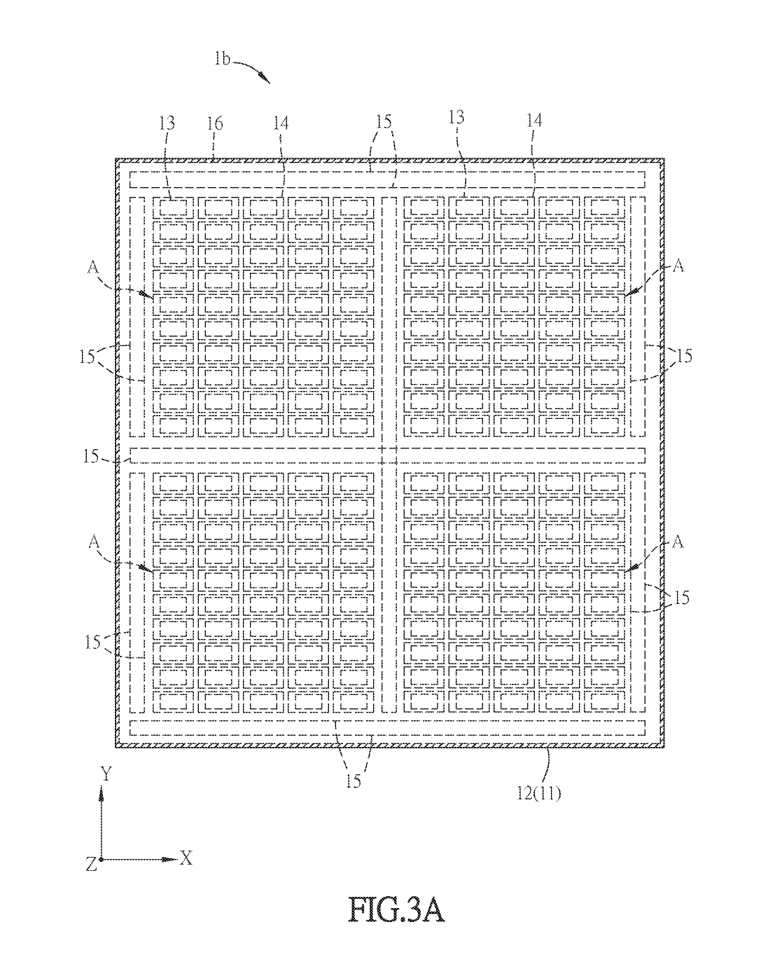

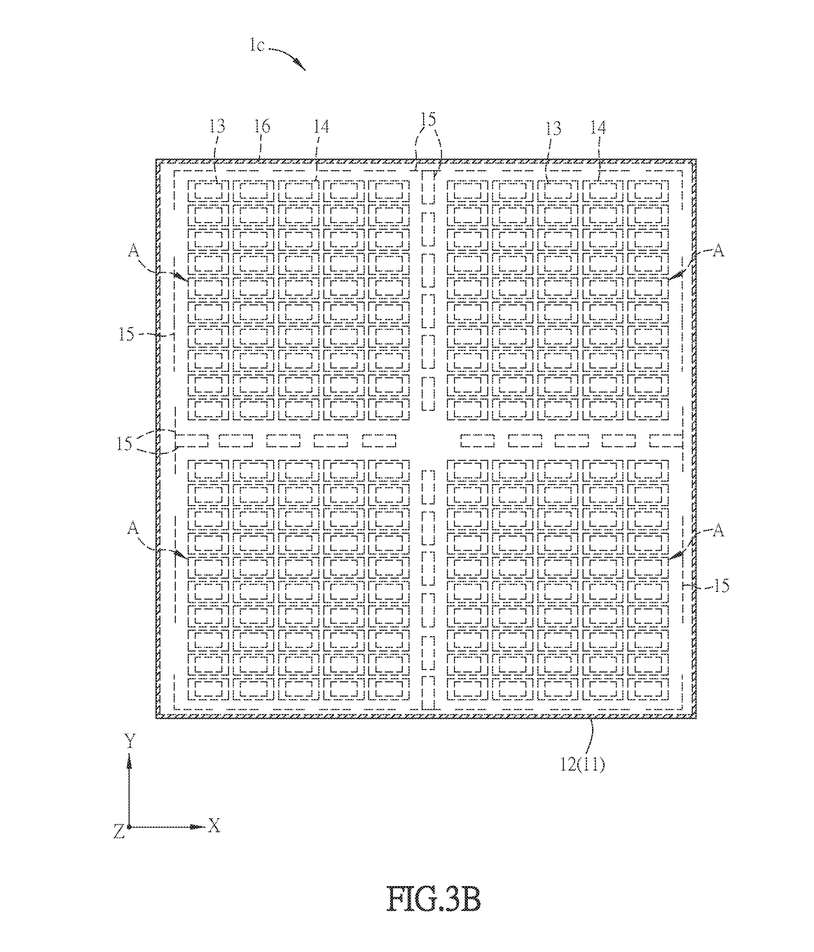

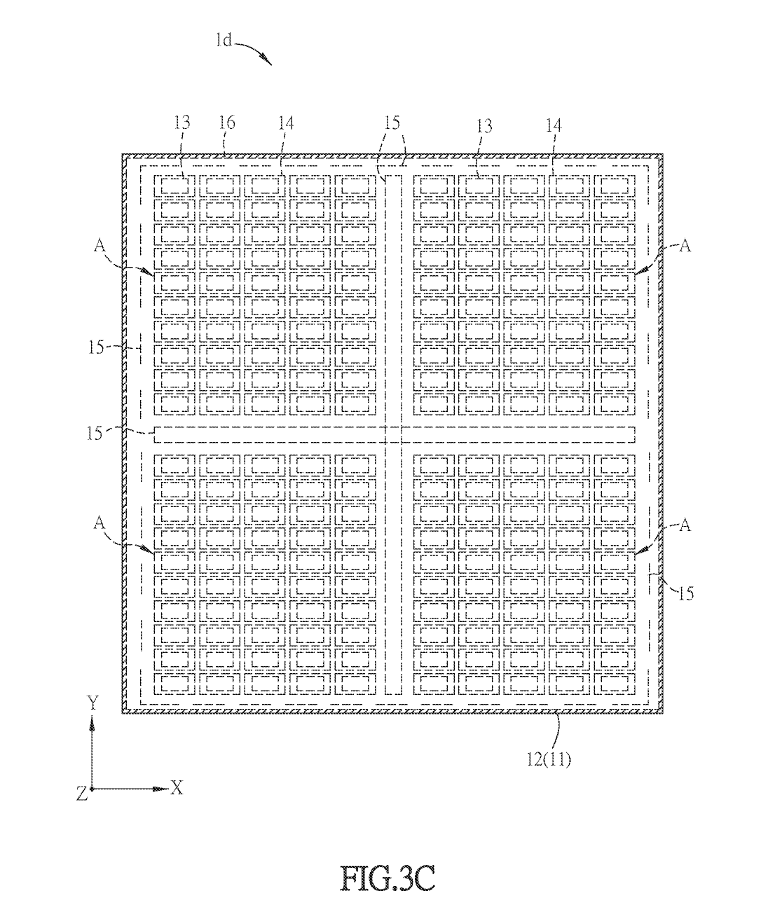

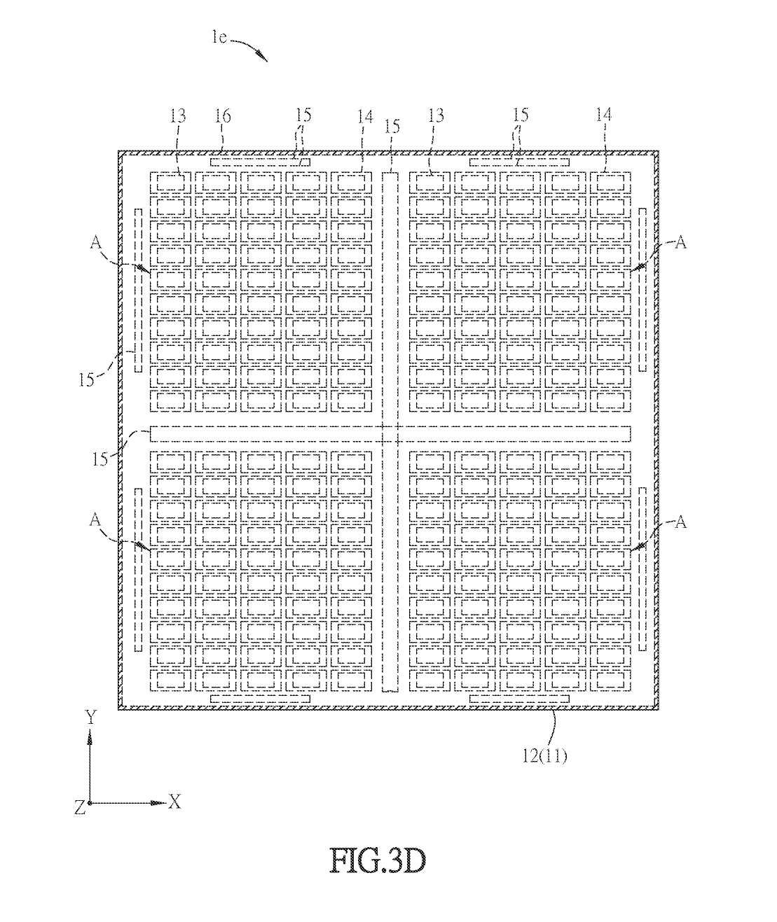

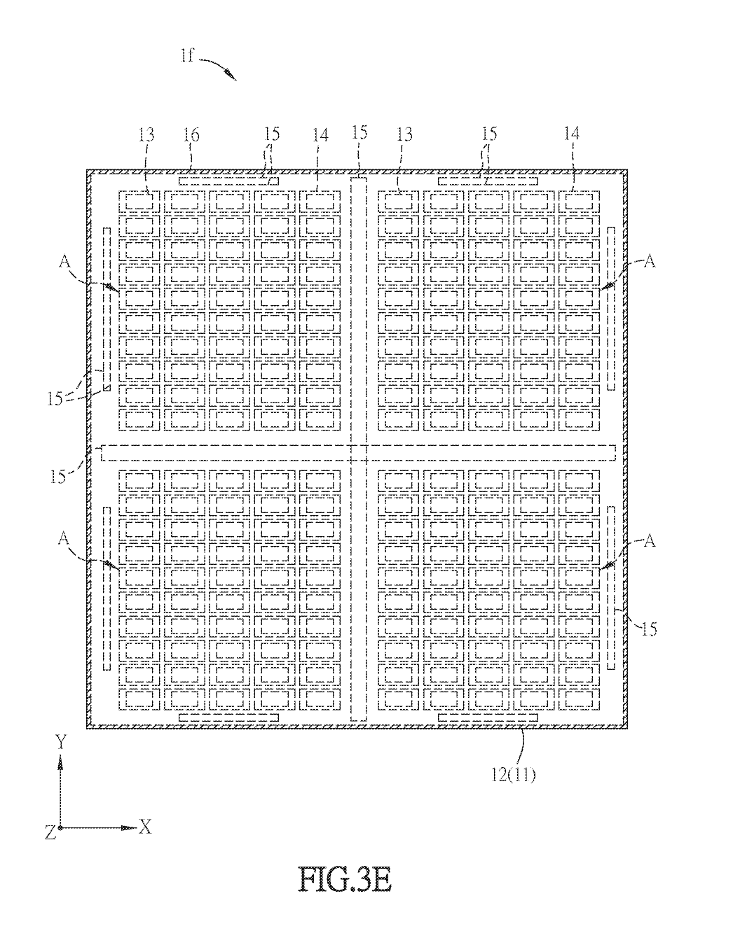

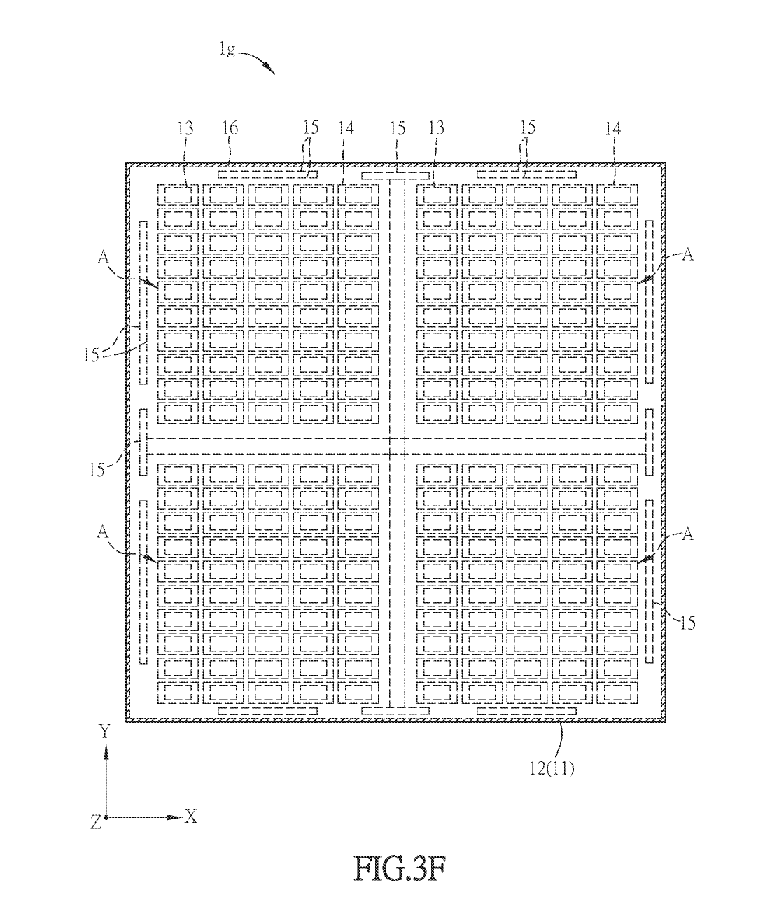

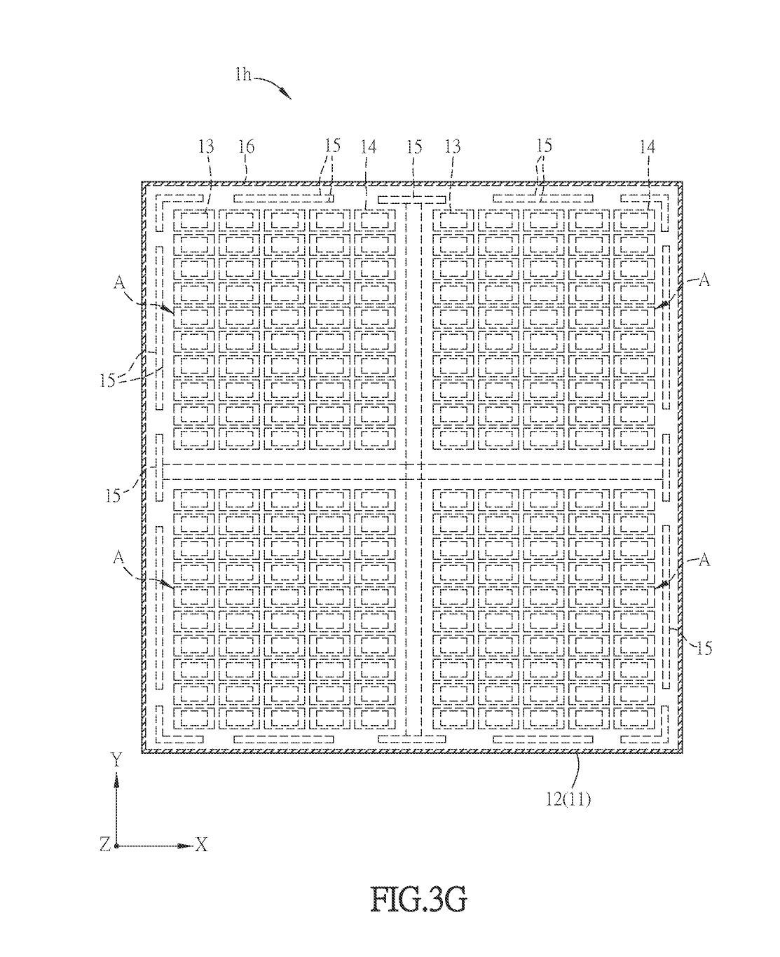

FIGS. 3A to 3G are schematic top-view diagrams of the display panel structures 1b˜1h of different embodiments of the invention.

As shown in FIG. 3A, the main difference from the display panel structure 1a in FIG. 2A is that each of the second sealants 15 of the display panel structure 1b is disposed between the edges of the arrays A and the first substrate 11 and is a double-layer structure without openings (i.e. the second sealant 15 is a continuous structure without segments), and the double-layer structure forms a closed space. Moreover, the adjacent second sealants 15 disposed on the upper or lower side of the first substrate 11 are connected with each other but not connected with the second sealants 15 disposed on the left or right side of the first substrate 11. Furthermore, each of the sealants 15 disposed between the left or right edges of the array A and the first substrate 11 is not connected with the adjacent second sealants 15. Besides, the second sealants 15 disposed in the cross-like interval regions of the arrays A are connected with each other and formed into a closed cross shape and are also formed into a shape like “#” in the middle portion of the four-section board, but they are not connected with the second sealants 15 which are disposed on the upper, lower, left and right sides.

Other technical features of the display panel structure 1b can be comprehended by referring to the display panel structure 1a, so the related illustration is omitted here for conciseness.

As shown in FIG. 3B, the main difference from the display panel structure 1b in FIG. 3A is that each of the second sealants 15 of the display panel structure 1c disposed between the edges of the arrays A and the first substrate 11 is a single-layer and multi-segment structure. Moreover, the second sealants 15, which are disposed in the cross-like interval regions defined by the arrays A, are double-layer and multi-segment structures and formed into a cross shape, and are connected with the peripheral second sealants 15.

Other technical features of the display panel structure 1c can be comprehended by referring to the display panel structure 1b, so the related illustration is omitted here for conciseness.

As shown in FIG. 3C, the main difference from the display panel structure 1b in FIG. 3A is that each of the second sealants 15 of the display panel structure 1d disposed between the edges of the arrays A and the first substrate 11 is a single-layer and multi-segment structure.

Other technical features of the display panel structure 1d can be comprehended by referring to the display panel structure 1b, so the related illustration is omitted here for conciseness.

As shown in FIG. 3D, the main difference from the display panel structure 1b in FIG. 3A is that each of the second sealants 15 of the display panel structure 1e disposed between the edges of the arrays A and the first substrate 11 is a double-layer structure but shorter, and the adjacent second sealants 15 disposed between the upper or lower edges of the arrays A and the first substrate 11 are not connected to each other.

Other technical features of the display panel structure 1e can be comprehended by referring to the display panel structure 1b, so the related illustration is omitted here for conciseness.

As shown in FIG. 3E, the main difference from the display panel structure 1e in FIG. 3D is that the second sealants 15 of the display panel structure 1f, which are disposed in the cross-like interval regions, are formed into a cross shape extending upwards, downwards, leftwards and rightwards to reach to between the other adjacent second sealants 15.

Other technical features of the display panel structure if can be comprehended by referring to the display panel structure 1e, so the related illustration is omitted here for conciseness.

As shown in FIG. 3F, the main difference from the display panel structure if in FIG. 3E is that the two adjacent second sealants 15 of the display panel structure l g, which are disposed between the upper, lower, left or right edges of the arrays A and the first substrate 11, are divided into three segments, and the cross-like second sealants 15 extend upwards, downwards, leftwards and rightwards to connect to the second sealants 15 of the upper, lower, left and right sides, respectively.

Other technical features of the display panel structure 1g can be comprehended by referring to the display panel structure 1f, so the related illustration is omitted here for conciseness.

As shown in FIG. 3G, the main difference from the display panel structure 1g in FIG. 3F is that second sealants 15 of the display panel structure 1h disposed between the edges of the arrays A and the first substrate 11 at the four corners include four double-layer structures, respectively.

Other technical features of the display panel structure 1h can be comprehended by referring to the display panel structure 1g, so the related illustration is omitted here for conciseness.

Summarily, in the display panel structure of this invention, the array is disposed between the first substrate and the second substrate and the LCD units are disposed within the array. Besides, the first sealants are disposed around the LCD units, respectively, and the second sealant is disposed on the outside of the array in a multi-segment manner. Thereby, in comparison with the conventional art, the problems of the substrate peeling and fragment occurring during the process of forming the transparent conducting layer for the display panel structure under vacuum can be improved, and the internal strike effect occurring when the first substrate and the second substrate are attached to each other under vacuum and then return to the atmosphere environment can be restrained, so as to enhance the technical yield.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display panel structure, comprising:
a first substrate;
a second substrate disposed corresponding to the first substrate;
at least an array disposed between the first substrate and the second substrate;
a plurality of liquid crystal display (LCD) units disposed within the array;
a plurality of first sealants disposed on the outside of the LCD units, respectively; and
at least a second sealant disposed on the outside of the array in a multi-segment manner.

2. The display panel structure as recited in claim 1, wherein the second sealant disposed between the edges of the array and the first substrate is a double-layer and multi-segment structure.

3. The display panel structure as recited in claim 2, wherein the second sealant disposed between the edges of the array and the first substrate at each of four corners includes a double-layer structure.

4. The display panel structure as recited in claim 1, wherein the distance between two adjacent segments of the second sealant is greater than 3 cm.

5. The display panel structure as recited in claim 1, wherein the length of each segment of the second sealant is less than or equal to 30 cm.

6. The display panel structure as recited in claim 1, further comprising:
at least a transparent conducting layer disposed on an outer surface of the first substrate or second substrate.

7. The display panel structure as recited in claim 6, wherein the transparent conducting layer is a polycrystalline patterned transparent conducting layer.

8. The display panel structure as recited in claim 1, wherein the display panel structure comprises a plurality of arrays and a plurality of second sealants disposed between the arrays.

9. The display panel structure as recited in claim 8, wherein the second sealants are disposed between the edges of the arrays and the first substrate.

10. The display panel structure as recited in claim 8, wherein the second sealants are arranged into an array formed by columns and rows, and the two adjacent second sealants along the column direction or row direction form an interval region.

11. The display panel structure as recited in claim 1, wherein the LCD units are fringe field switching (FFS) LCD units or in-plane switch (IPS) LCD units.

12. The display panel structure as recited in claim 1, further comprising:
a third sealant sealing the edges of the first substrate and second substrate.

13. The display panel structure as recited in claim 1, wherein the first sealant forms a containing space, and liquid crystal molecules are filled into the containing space.

14. The display panel structure as recited in claim 8, wherein the second sealants disposed between the edges of the array and the first substrate are double-layer structures without openings.

15. The display panel structure as recited in claim 14, wherein the double-layer structure forms a closed space.

16. The display panel structure as recited in claim 8, wherein the second sealants disposed between the edges of the array and the first substrate are single-layer and multi-segment structures.

17. The display panel structure as recited in claim 16, wherein the second sealants, which are disposed in the cross-like interval regions defined by the arrays, are double-layer and multi-segment structures and formed into a cross shape.

18. The display panel structure as recited in claim 8, wherein the second sealants disposed between the edges of the array and the first substrate are single-layer and multi-segment structures, and are not connected with the second sealants disposed in the interval region formed between the arrays.

19. The display panel structure as recited in claim 8, wherein the second sealants disposed in the interval regions formed between the arrays are connected together to form a cross shape.

20. The display panel structure as recited in claim 8, wherein the second sealants disposed in the interval regions formed between the arrays are connected together to form a cross shape, and are connected with the second sealants disposed on the edges of the arrays.
